(19) United States
(12) Patent Application Publication
(10) Pub. No.: US 2025/0170442 A1
(43) Pub. Date: May 29, 2025

(54) SYSTEMS AND METHODS OF SPRINKLERS HAVING INTEGRAL THERMAL TRIGGER LEVERS

(71) Applicant: Tyco Fire Products LP, Cranston, RI (US)

(72) Inventor: Dileep Karuppilarikath Balakrishna, Bangalore (IN)

(73) Assignee: Tyco Fire Products LP, Cranston, RI (US)

(21) Appl. No.: 18/519,668

(22) Filed: Nov. 27, 2023

(51) Int. Cl. A62C 37/12

(52) U.S. Cl. CPC A62C 37/12

(57) ABSTRACT

A sprinkler includes a frame, a deflector, a seal, and a trigger. The frame includes a body forming an internal passageway between an inlet and an outlet along a longitudinal axis. The frame includes a pair of frame arms extending from the body to a base. The deflector is coupled with the base. The seal is disposed in the outlet. The trigger is coupled with the seal and the base. The trigger includes a first member coupled with the seal, a second member having an edge coupled with the first member, and a third member coupled with the first member and the second member, the edge offset from the longitudinal axis.

### BACKGROUND

Sprinkler systems can be used to address fire conditions. For example, the sprinkler system can include one or more sprinklers that receive fluid from a fluid supply and output the fluid to address the fire condition.

### SUMMARY

At least one aspect relates to a sprinkler. The sprinkler can include a frame, a deflector, a seal, and a trigger. The frame includes a body forming an internal passageway between an inlet and an outlet along a longitudinal axis. The frame includes a pair of frame arms extending from the se to a base. The deflector is coupled with the base. The seal is disposed in the outlet. The trigger is coupled with the seal and the base. The trigger includes a first member coupled with the seal, a second member having an edge coupled with the first member, and a third member coupled with the first member and the second member, the edge offset from the longitudinal axis.

At least one aspect relates to a trigger assembly of a sprinkler. The trigger assembly can include a first member, a second member, and a third member. The first member has a first end, a second end, and a curved portion between the first end and the second end. The second end includes a first receiver and a second receiver spaced from the first receiver. The curved portion includes a groove. The second member has an edge coupled with the groove. The third member is disposed between the first receiver and the second receiver. The third member has a material disposed in the third member. The material is to change state responsive to a temperature indicative of a fire condition meeting or exceeding a threshold temperature.

At least one aspect relates to a sprinkler assembly. The sprinkler assembly can include a body, a pair of frame arms, a deflector, a screw, a seal, and a trigger assembly. The body has a passageway between an inlet and an outlet along a longitudinal axis. The pair of frame arms are between the body and a base. The pair of frame arms are outward from the longitudinal axis. The deflector is coupled with the base. The screw is in a channel of the base. The seal is in the outlet. The trigger assembly includes a first member coupled with the seal. The first member is monolithic. The trigger assembly includes a second member coupled with the first member and the screw. The trigger assembly includes a third member having a first state to apply a force on the first member to hold the first member against the seal. The third member is to change from the first state to a second state to allow the first member to be released from the seal responsive to a temperature of a material in the third member meeting or exceeding a threshold temperature.

At least one aspect relates to a method of assembling a sprinkler assembly. The method can include coupling a seal with an outlet of a sprinkler. The method can include coupling a trigger assembly with the seal. The method can include translating a screw through a base of the sprinkler to apply a torque against a member of the trigger assembly to engage the trigger assembly with the seal.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a sprinkler system.

FIG. 2 is a perspective view of an example of a sprinkler assembly.

FIG. 3 is a cross-section view of an example of a sprinkler assembly.

FIG. 4 is a perspective view of an example of a lever of a trigger of a sprinkler assembly.

FIG. 5 is a perspective view of an example of button of a seal of a sprinkler assembly.

FIG. 6 is a perspective view of an example of a strut of a trigger of a sprinkler assembly.

FIG. 7 is a flow diagram of a method of assembling a sprinkler assembly.

### DETAILED DESCRIPTION

Following below are more detailed descriptions of various concepts related to, and implementations of systems and methods of sprinklers or sprinkler assemblies, such as sprinklers having integral or monolithic trigger assemblies. The various concepts introduced above and discussed in greater detail below can be implemented in any of numerous ways, including in residential ceiling implementations.

Sprinklers for addressing fire conditions, such as for fire protection or fire suppression, can include a trigger assembly that changes states in response to the fire condition. For example, the trigger assembly can include one or more components connected by a fuse, such as a fusible material, that melts or otherwise changes phase or state responsive to the temperature around the fusible material meeting or exceeding a target temperature for the fusible material, where the target temperature is representative of the fire condition.

The trigger assembly can include, for example, a lever, a pin, and a hook, which can be assembled together, such as by riveting the pin to the hook and lever, to form a lever portion of the trigger assembly. In assembly, the lever portion can be positioned to be compressed (e.g., having a spring force applied) as part of sealing a seal of the sprinkler. The assembled form of the pin, hook, and lever can make the trigger assembly more difficult to manufacture and assemble, and can require a relatively larger sprinkler frame for a given performance target (e.g., K-factor) for the sprinkler. For example, the trigger assembly can require manual assembly, in which spring forces are applied to the components of the trigger assembly to properly arrange the trigger assembly with respect to the sprinkler, thus making assembly challenging with many parts; similarly, the number of parts and/or manipulations to perform the assembly can require increasing the size of the sprinkler frame to provide space for such considerations.

Systems and methods in accordance with the present disclosure can include trigger assemblies in which at least the lever is formed as an integral or monolithic member. For example, the lever can be entirely cast or molded as a single piece between a first end that is to engage the seal (e.g., contact a groove in a sprinkler button of the seal) and a second end that forms receivers and/or slots to receive the tube in which the fusible material is provided. The sprinkler can include a compression screw that can be translated along a longitudinal axis of the sprinkler, such as to facilitate compression of the lever and/or other components of the trigger assembly. The trigger assembly can include a strut that is assembled to have a first end to contact the compression screw and a second end to contact the lever, where the first end is positioned to coincide with the longitudinal axis while the second end is offset from the longitudinal axis, to facilitate compression and/or assembly of the sprinkler using the integral lever, as well as to ensure that the fusible material (e.g., fusible tube) is properly positioned upon assembly.

For example, a sprinkler assembly can include a body, a pair of frame arms, a deflector, a screw, a seal, and a trigger assembly. The body can have a passageway between an inlet and an outlet along a longitudinal axis. The pair of frame arms can be between the body and a base. The pair of frame arms can be outward from the longitudinal axis. The deflector can be coupled with the base. The screw can be in a channel of the base. The seal can be in the outlet. The trigger assembly can include a first member coupled with the seal. The first member can be monolithic. The trigger assembly can include a second member coupled with the first member and the screw; the second member can be angled relative to the longitudinal axis to facilitate setting the first member into a lever state. The trigger assembly can include a third member having a first state to apply a force on the first member to hold the first member against the seal. The third member can change from the first state to a second state to allow the first member to be released from the seal responsive to a temperature of a material in the third member meeting or exceeding a threshold temperature.

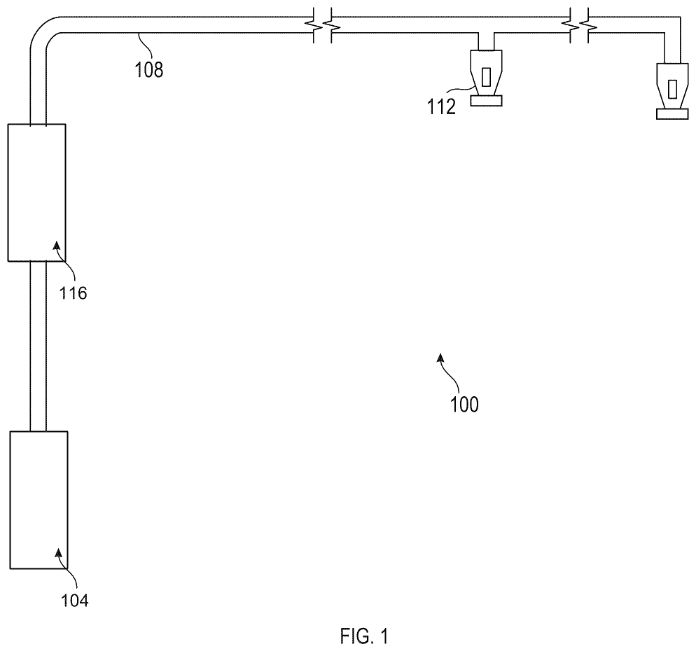

FIG. 1 depicts an example of a sprinkler system 100. The sprinkler system 100 can include a fluid supply 104. The fluid supply 104 can store fluids to be used to address a fire condition, which can include at least one of water and one or more fire suppression agents.

The sprinkler system 100 can include one or more pipes 108. The pipes 108 can be connected with the fluid supply 104 and extend from the fluid supply 104. The pipes 108 can extend through a structure, such as a building. Fluid from the fluid supply 104 can be present in the pipes 108 and flow through the pipes 108. The pipes 108 can include any of a variety of conduits that can be used to flow fluid (e.g., water or other fire suppression agents), including but not limited to piping, tubing, metal pipes, rigid pipes, or polymeric (e.g., chlorinated polyvinyl chloride (CPVC)) pipes.

The sprinkler system 100 can include at least one sprinkler 112. The sprinkler 112 can receive fluid from the fluid supply 104 through the one or more pipes 108 and output the fluid to address a fire condition. The sprinkler 112 can be a concealed sprinkler. The sprinkler 112 can have various K-factors.

The one or more pipes 108 can extend through at least a portion of a building structure. A cavity can be formed in the building structure to receive the sprinkler 112. The sprinkler 112 can be at least partially positioned in the cavity to be coupled with the one or more pipes 108. The cavity can be at least partially open to a space below the ceiling, such as a space that the sprinkler 112 is used to protect in the event of a fire condition. The sprinkler 112 can be arranged in or coupled with a sprinkler box provided in the cavity. The sprinkler box can be a box used to support or install the sprinkler 112 in the ceiling, such as in a concrete ceiling installation. The sprinkler system 100 can include one or more valves 116, such as flow control valves, to facilitate fluid flow to the sprinklers 112.

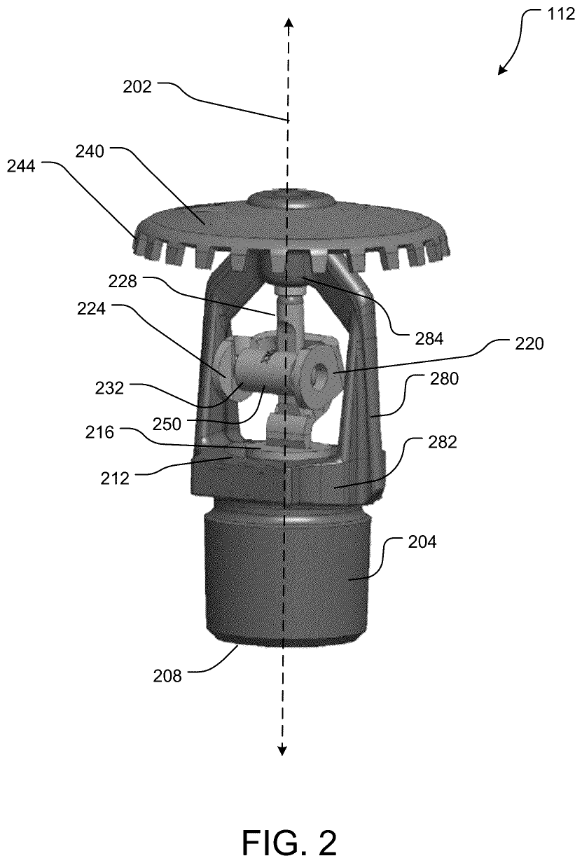

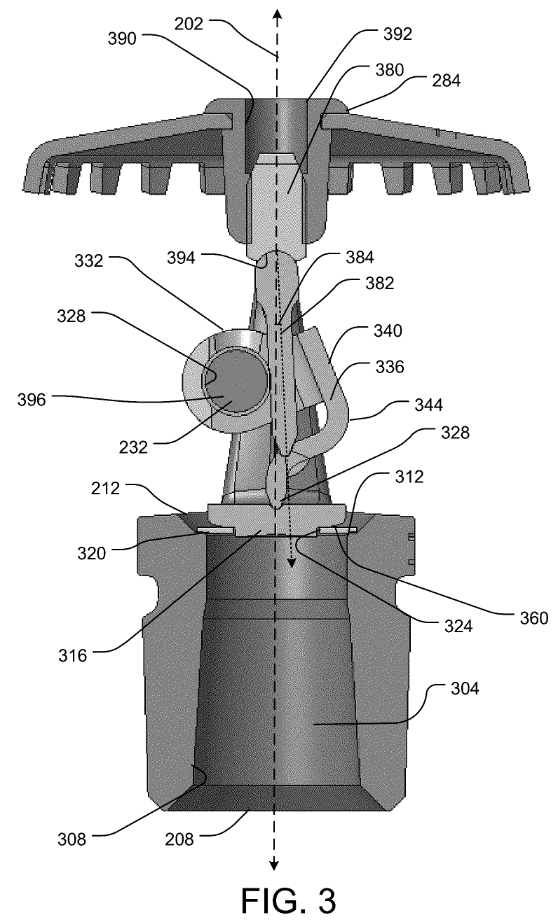

FIGS. 2 and 3 depict an example of the sprinkler 112 (e.g., a sprinkler assembly). The sprinkler 112 can include a body 204. The body 204 can be solid cast or molded structure. The body 204 can form a passageway 304 along a longitudinal axis 202. For example, the body 204 can have an inner wall 308 that forms the passageway 304. The passageway 304 can be between an inlet 208 and an outlet 212.

The passageway 304 can have various form factors; for example, the passageway 304 can have portions that increase or decrease in diameter; as depicted in FIG. 3, the passageway 304 can decrease in diameter from the inlet 208 to a seal receiver 312 (e.g., a surface of the passageway 304 that changes direction to form a shelf or shoulder for seal 216), and can increase in diameter from the seal receiver 312 to the outlet 212. The seal receiver 312 can be a shoulder of the inner wall 308. The inlet 208 can connect with one or more pipes 108 to receive fluid from the one or more pipes 108.

The body 204 can include or be coupled with one or more frame arms 280, such as a pair of frame arms 280. The frame arms 280 can extend to be disposed outward of the longitudinal axis 202 from a portion 282 of the body 204 proximate the outlet 212 to a base 284. The frame arms 280 can be integrally formed with the body 204, or can be separate members coupled with the body 204. The portion 282 can form one or more wrench flats or other features to be manipulated by a tool for installation of the sprinkler 112.

The sprinkler 112 can include a seal 216 that seals the outlet 212. The seal 216 can include a button 316 and a spring 320 (e.g., Belleville spring) coupled with the button 316 between the button 316 and the inner wall 308 of the passageway 304. For example, as described further herein, compression applied to trigger assembly 220 can cause the spring 320 to be compressed to seal the inlet side of the passageway 304 from the outlet 212. The spring 320 can define an opening 324 to receive the button 316. The spring 320 can be an annular member, and can have a thickness less than a radius, such as to be a flat or relatively flat member.

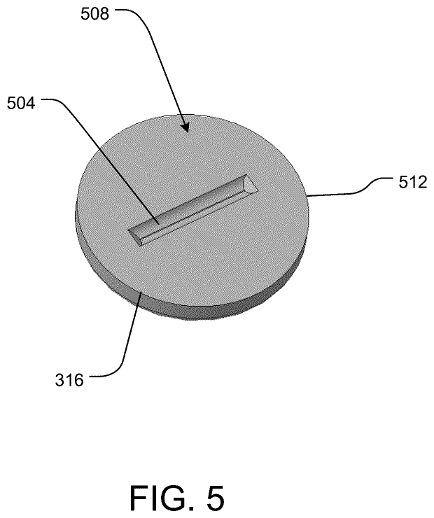

As depicted in FIG. 5, the button 316 can be a disc having a groove 504. The groove 504 can extend at least partially across a centerline of the button 316. The groove 504 can be defined down into a surface 508 of the button 316; the surface 508 can be flat outward from the groove 504 to an edge 512. As depicted in FIG. 3, a surface of the button 316 opposite the surface 508 can form an annular shoulder 360 to couple with the spring 320. The seal 216 can be compressed against the shoulder 360 to form a fluid-tight seal against pressure of fluid (e.g., air in dry systems; water in wet systems) in the passageway 304.

The sprinkler 112 can include a trigger assembly 220. The trigger assembly 220 can be coupled with the seal 216 to maintain the seal 216 in a first state in which the seal 216 seals the outlet 212. For example, the trigger assembly 220 can be under sufficient compression to apply a sufficient force against the seal 216 to maintain the seal 216 in the outlet 212 against pressure of fluid (e.g., air or water) in the passageway 304 acting on the seal 216.

The trigger assembly 220 can include one or more components that change state from the first state to a second state by being activated responsive to a fire condition (e.g., responsive to temperature or a rate of rise of temperature meeting or exceeding a threshold value). In the second state, at least a portion of the trigger assembly 220 can be separated from a remainder of the trigger assembly 220. This can allow the seal 216 to be displaced from the outlet 212 due to pressure of fluid in the passageway 304 on the outlet 212.

As depicted in FIGS. 2, 3, and 4, the trigger assembly 200 can include a first member 224. The first member 224 can be a lever (e.g., a hook and lever assembly). The first member 224 can be formed as an integral and/or monolithic structure, such as to be cast or molded as a single member, or to be fixedly joined to form the integral first member 224. This can allow the first member 224 to more easily be assembled together with other components of the trigger assembly 200 and/or the sprinkler 112, such as for driving screw 380 against second member 228 to apply pressure on the seal 216 (e.g., by way of the first member 224) to hold the seal 216 against pressure of fluid in the passageway 304.

The first member 224 can have a first end 328, a second end 332, and a portion 336 between the first end 328 and second end 332. The portion 336 can be curved or arcuate, which can allow the first member 224 to form a space for second member 228 (e.g., a strut) and third member 232 (e.g., a fusible tube, a fusible link). The first end 328 can engage the groove 504 of the button 316 to hold the seal 216 in the outlet 212 against pressure from fluid in the passageway 304. The first member 224 can be intersected by and/or cross the longitudinal axis 202 at multiple points.

The portion 336 can include a groove 416. The groove 416 can be disposed across the portion 336 (e.g., transverse to a path along the portion 336 from the first end 328 to the second end 332). The groove 416 can receive second member 228, and can be offset from (e.g., at a nonzero distance from in the assembled state depicted in FIG. 3) the longitudinal axis 202 in the assembled sprinkler 112. The groove 416 can be formed at or proximate (e.g., within ten percent of the arc length of the portion 336) an inflection point of the curvature of the portion 336 where the curvature changes from convex to concave (e.g., with respect to the surface of the portion 336 into which the groove 416 is formed).

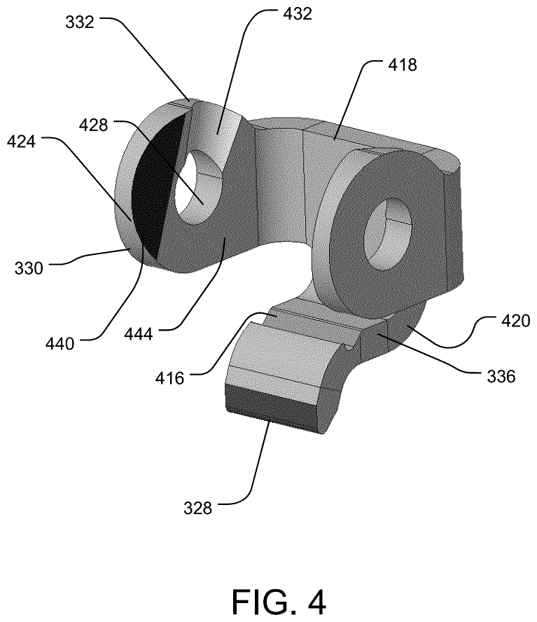

The portion 336 can include a wall 340 between the groove 416 and the second end 332. The wall 340 can extend to an edge 418, which can extend at least partially in a direction parallel with the groove 416. As depicted in FIGS. 3 and 4, the wall 340 can have a first wall portion 344 that has the same or substantially the same (e.g., within ten percent) width as a remainder of the portion 336, and the wall 340 can extend from the first wall portion 344 outward and/or around the longitudinal axis 202 to a pair of second wall portions 424 that form tube receivers 330 of the second end 332 to receive third member 232.

For example, as depicted in FIG. 3, the first wall portion 344 can be a part of the first member 224 that is furthest in the plane of FIG. 3 (e.g., a plane in which longitudinal axis 202 lies and which is perpendicular to an axis through the frame arms 280) from the first end 328 and on an opposite side of the longitudinal axis 202 from the first end 328, and from which the second wall portions 424 curve back across the longitudinal axis 202 to form the tube receivers 330 at the second end 332.

The tube receivers 330 can be further outward from the longitudinal axis 202 than outer edges of the first end 328. The tube receivers 330 can form holes 428 that extend at least partially through the tube receivers 330 (e.g., fully through the tube receivers 330 as depicted in FIG. 4) to receive respective ends of the third member 232. The tube receivers 330 can include slots 432 disposed, for example, from edges of the tube receivers 330 to the holes 428, which can facilitate assembly for positioning the third member 232 in the tube receivers 330. For example, the third member 232 can be slid along the slots 432 until received in the holes 428 of the tube receivers 330 to be engaged with the first member 224. The tube receivers 330 (e.g., at second end(s) 332) can have angled surfaces 440 that angle outward from surfaces 444 relative to the plane of FIG. 3, which can facilitate ejection of the third member 232 responsive to operation of the sprinkler 112.

As depicted in FIGS. 3 and 4, the first member 224 (e.g., the structure of the first member 224 around from the first end 328 to the second end 332) can be sized so that the first end 328 (e.g., the tip formed at the first end 328) is positioned on and/or aligned with the longitudinal axis 202, the holes 428 are on a first side of the longitudinal axis 202 (e.g., on a first side of a plane in which the longitudinal axis 202 lies and that is perpendicular to the plane of FIG. 3), and the groove 416 is on a second side of the longitudinal axis 202 (e.g., on a second side of the plane in which the longitudinal axis 202 lies and that is perpendicular to the plane of FIG. 3). This can allow the first member 224 to be effectively used as a lever against the seal 216 and/or to operate with the second member 228 and third member 232 to disengage trigger assembly 200 away from the seal 216 and flow path out of the outlet 212 responsive to a fire condition.

The sprinkler 112 can include a screw 380. The screw 380 can be disposed in a channel 390 formed in the base 284. For example, the screw 380 can be translated from an opening 392 formed at a distal end of the channel 390 opposite the body 204. The channel 390 can be shaped to retain the screw 380 (e.g., due to friction between the screw 380 and the channel 390 resulting from the shapes of the outer surface of the screw 380 and of the channel 390) as the screw 380 is translated from the opening 392 towards the body 204, which can enable the screw 380 to apply compressive force on the second member 228.

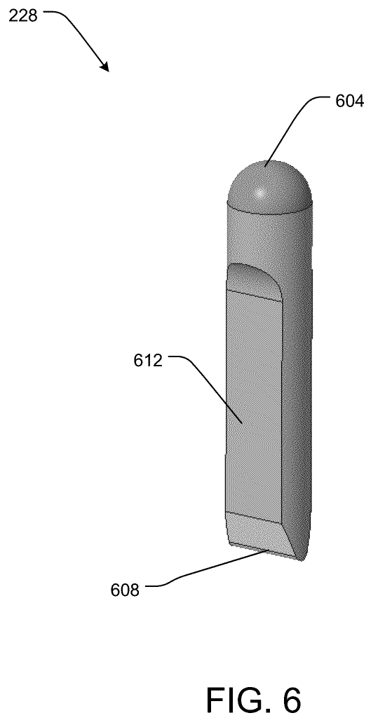

As depicted in FIG. 3, the screw 380 can include a receiver 394. The receiver 394 can be shaped to engage with the second member 228. For example, the receiver 394 can have a concave shape to receive the convex shape of first end 604 (see FIG. 6) of the second member 228.

The receiver 394 can extend further radially outward (e.g., relative to longitudinal axis 202) than the first end 604 to more effectively hold and apply compressive force to the second member 228. The curvature of the receiver 394 can allow the second member 228 to be pivoted relative to the longitudinal axis 202 as the screw 380 is translated towards the body 204, such as to enable the first member 224 to operate as a lever arm.

As depicted in FIGS. 2, 3, and 6, the second member 228 can be a tubular structure, and can have a first end 604 and a second end 608. The first end 604 can be structured to couple with the screw 380. The first end 604 can be convex, such as to form a convex spherical or cylindrical surface.

The second end 608 can be structured to engage the groove 416 of the first member 224. For example, where the groove 416 forms an opening or channel as depicted in FIGS. 2-4, the second end 608 can form an edge, such as a conical edge or an edge having multiple surfaces, to be received in the groove 416. The engagement can allow for compression of the second member 228 by the screw 380 to drive a force into the groove 416 and, in turn, against the seal 216.

As depicted in FIG. 6, the second member 228 can have a concave portion 612 between the first end 604 and the second end 608. The concave portion 612 can have a concavity (e.g., concave surface curvature) matching a convexity (e.g., convex surface curvature) of the third member 232 so that the second member 228 can fit against the third member 232. The concave portion 612 can extend along at least a portion of a first longitudinal half of the second member 228 that facets the third member 232.

As depicted in FIGS. 3 and 4, the groove 416 can be positioned on an opposite side of a plane that is through the longitudinal axis 202 and perpendicular to the plane of FIG. 3 relative to the second end 608 of the second member 228. For example, an axis 382 through the first end 604 and second end 608 of the second member 228 can form an angle 384 with the longitudinal axis 202 at the first end 604. The angle 384 can be greater zero degrees and less than or equal to 45 degrees, or 30 degrees, or 15 degrees.

Due to the positioning to form the angle 384, the second end 608 can be offset from the longitudinal axis 202 (e.g., positioned at a nonzero distance from the longitudinal axis 202 in the assembled state depicted in FIG. 3). Due to the offset positioning, the force created by the screw 380 and second member 228 can be perpendicular to the second member 228, and the angle of the slots 432 will not be perpendicular to that force created by the screw 380 and the second member 228. This can help ensure the third member 232 remains in place after assembling.

As depicted in FIGS. 2 and 3, the third member 232 can include a tube 250 coupled with a pair of seals 396 on either end of the tube 250. For example, the tube 250 can house (e.g., contain, hold, have disposed within) an alloy, such as a fusible alloy or solder material. The seals 396 can be stainless steel members, such as stainless steel spherical members (e.g., balls). The seals 396 can have a higher melting temperature than the alloy disposed in the tube 250. The position of the tube 250 along with the first member 224 and the groove 416 of the first member 224 (e.g., operating as a lever) can allow the second member 228 to be assembled in the offset manner responsive to sufficient torque from the screw 380 being applied on the first end 604 of the second member 228.

Responsive to a temperature of the alloy meeting or exceeding a threshold indicative of a fire condition (e.g., due to heat from a fire), the alloy can melt, which can allow the seals 396 to be driven towards each other (e.g., having been spaced apart by the alloy against compressive force from the tube receivers 330). This can release the trigger assembly 200 (e.g., from compression of the trigger assembly 200 by screw 380) to allow the first end 328 of the first member 224 to be displaced from the groove 504 of the button 316 to allow the seal 216 to be released from the outlet 212.

As depicted in FIGS. 2 and 3, the sprinkler 112 can include a deflector 240 downstream of the outlet 212. The deflector 240 can include or be coupled with a nosecone. The deflector 240 can receive the fluid that flows out of the outlet 212 (e.g., subsequent to release of the seal 216 from the outlet 212) and deflect the fluid according to a target spray pattern (e.g., a spray pattern corresponding to the geometry of the deflector 240). The deflector 240 can be coupled with the body 204 so that the longitudinal axis 202 extends through the deflector 240.

The deflector 240 can include a plurality of tines 244 to facilitate deflecting the fluid according to the target spray pattern. The tines 244 can have various sizes (e.g., angular extents) and spacings between tines 244 to direct fluid to portions of spaces, such as to coverage areas, stored commodities, walls, windows, and/or corners of spaces.

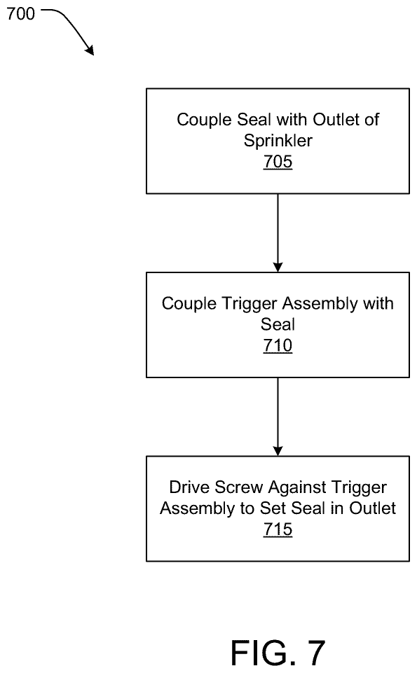

FIG. 7 depicts an example of a method 700 of assembling a sprinkler assembly. The method can be implemented by performing various types of assembly and/or manufacturing operations. The method can be performed to set a threshold amount of force and/or pressure on a seal of a sprinkler to prepare the sprinkler for operation.

At 705, a seal can be coupled with an outlet of a sprinkler. For example, the seal can include a button coupled with a spring. The spring can be positioned in the outlet, with the button disposed such that the spring is between the button and a fluid passageway of the sprinkler.

At 710, a trigger assembly can be coupled with the seal. For example, one or more of a lever, a strut, and/or a fusible material tube can be positioned so that the lever engages the button, and the trigger assembly is positioned in a space between the outlet and a base of the sprinkler (e.g., along a longitudinal axis of the sprinkler through the fluid passageway and the base, such as between frame arms of the sprinkler from a body forming the fluid passageway to the base. At least the lever of the trigger assembly can be formed as an integral and/or monolithic member, which can facilitate assembling the trigger assembly with the sprinkler by reducing a number of components and/or actions to manipulate the components compared with systems that may include pins and/or rivets of the lever.

At 715, a screw can be translated through the base to apply a torque against the strut of the trigger assembly, which in turn can apply force against the seal to hold the seal in the outlet. For example, the translation can cause the strut to be forced against the lever on a first side of the longitudinal axis opposite a second side in which the tube is oriented, which can assemble the trigger assembly for proper release from the sprinkler responsive to a fire condition. For example, the lever and fusible tube can be pre-assembled; the strut can be aligned with a groove of the lever positioned to receive the strut offset from the longitudinal axis, and the torque can be applied from the screw to hold the trigger assembly in tension to allow the sprinkler to operate.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “implementations,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A sprinkler, comprising:
a frame, comprising:
a body forming an internal passageway between an inlet and an outlet along a longitudinal axis; and
a pair of frame arms extending from the body to a base;
a deflector coupled with the base;
a seal disposed in the outlet; and
a trigger coupled with the seal and the base, the trigger comprising a first member coupled with the seal, a second member having an edge coupled with the first member, and a third member coupled with the first member and the second member, the edge offset from the longitudinal axis.

2. The sprinkler of claim 1, comprising:
the first member has a first end in contact with the seal and a second end forming one or more slots to receive the third member, the first member is at least one of an integral or monolithic from the first end to the second end.

3. The sprinkler of claim 1, comprising:
the first member is disposed across the longitudinal axis; and
the third member is away from to the longitudinal axis.

4. The sprinkler of claim 1, comprising:
the third member is made of a fusible material to change state responsive to a temperature around the third member meeting or exceeding a threshold temperature, the threshold temperature is at least 150 degrees Fahrenheit.

5. The sprinkler of claim 1, comprising:
a screw received along the longitudinal axis in a channel of the base, the screw comprising a screw end having one of a concave surface or a convex surface in contact with the second member to couple the second member with the base; and
the second member comprises a member end in contact with the screw end, the member end having the other of the concave surface or the convex surface.

6. The sprinkler of claim 1, comprising:
the seal comprises a button forming a receiver to receive an end of the first member.

7. The sprinkler of claim 1, comprising:
the first member is positioned to cross the longitudinal axis at multiple points.

8. A trigger assembly of a sprinkler, comprising:
a first member having a first end, a second end, and a curved portion between the first end and the second end, the second end comprising a first receiver and a second receiver spaced from the first receiver, the curved portion comprising a groove;
a second member having an edge coupled with the groove; and
a third member disposed between the first receiver and the second receiver, the third member having a material disposed in the third member, the material to change state responsive to a temperature indicative of a fire condition meeting or exceeding a threshold temperature.

9. The trigger assembly of claim 8, comprising:
the first member defines a longitudinal axis through the first end, the second end and the third member are on a first side of the longitudinal axis, and the groove and the edge of the second member are on a second side of the longitudinal axis opposite the first side.

10. The trigger assembly of claim 8, comprising:
the second member comprises a convex surface opposite the edge, the convex surface shaped to be engaged by a screw of the sprinkler.

11. The trigger assembly of claim 8, comprising:
the first member is a monolithic member.

12. The trigger assembly of claim 8, comprising:
the third member is offset from a longitudinal axis through the first end of the first member and a convex surface of the second member opposite the edge.

13. The trigger assembly of claim 8, comprising:
the threshold temperature is at least 150 degrees Fahrenheit.

14. A sprinkler assembly, comprising:
a body having a passageway between an inlet and an outlet along a longitudinal axis;
a pair of frame arms between the body and a base, the pair of frame arms outward from the longitudinal axis.
a deflector coupled with the base;
a screw in a channel of the base;
a seal in the outlet; and
a trigger assembly, comprising:
a first member coupled with the seal, the first member is monolithic;
a second member coupled with the first member and the screw; and
a third member having a first state to apply a force on the first member to hold the first member against the seal, the third member to change from the first state to a second state to allow the first member to be released from the seal responsive to a temperature of a material in the third member meeting or exceeding a threshold temperature.

15. The sprinkler assembly of claim 14, comprising:
the first member has a first end in contact with the seal and a second end forming one or more slots in which the third member is received.

16. The sprinkler assembly of claim 14, comprising:
the first member is disposed across the longitudinal axis at multiple points; and
the third member is coupled with the first member at a position away from the longitudinal axis.

17. The sprinkler assembly of claim 14, comprising:
the second member comprises a convex surface in contact with the screw and an edge opposite the convex surface, the edge received in a groove of the first member.

18. The sprinkler assembly of claim 14, comprising:
the second member an edge received in a groove of the first member, the edge and the groove on an opposite side of the longitudinal axis from the third member.

19. The sprinkler assembly of claim 14, comprising:
the seal comprises a button forming a receiver to receive an end of the first member.

20. The sprinkler assembly of claim 14, comprising:
the first member comprises a first end coupled with the seal, a second end having a pair of receivers coupled with the third member, a curved portion between the first end and the second end, and a groove between the first end and the curved portion, the groove coupled with the second member.
